(19) United States
(12) Patent Application Publication
(10) Pub. No.: US 2026/0138331 A1
(43) Pub. Date: May 21, 2026

(54) PRINT BED ASSEMBLY FOR ADDITIVE MANUFACTURING SYSTEM

(71) Applicant: ULTIMAKER B.V., Geldermalsen (NL)

(72) Inventor: Jirí KONVICNÝ, Geldermalsen (NL)

(73) Assignee: ULTIMAKER B.V., Geldermalsen (NL)

(21) Appl. No.: 19/117,112

(22) PCT Filed: Sep. 25, 2023
(86) PCT No.: PCT/NL2023/050498

§ 371 Date: Mar. 31, 2025

(30) Foreign Application Priority Data
Oct. 6, 2022 (NL) 2033245

(51) Int. Cl. B29C 64/245; B33Y 30/00

(52) U.S. Cl. CPC B29C 64/245; B33Y 30/00

(57) ABSTRACT

A print bed assembly for an additive manufacturing system comprises a stage (202), a carrier plate (204) comprising an upper surface (206) extending in an X-and a Y-direction, a support structure (220) arranged on the stage and comprising a straight edge extending in the X-direction, a build plate, and at least one abutment to align the build plate relative to the carrier plate in the Y-direction. In a first state S1 when the build plate is placed on the support structure at an angle (A1) relative to the upper surface of the carrier plate, the build plate touches the straight edge of the support structure and the at least one abutment. In a second state S2 when the build plate is placed down onto the upper surface of the carrier plate, the build plate stays aligned since it still touches the at least one abutment.

### FIELD OF THE INVENTION

The present invention relates to a print bed assembly for an additive manufacturing system. The present invention also relates to an additive manufacturing system comprising such a print bed assembly.

### BACKGROUND ART

Fused filament fabrication (FFF) is an additive manufacturing process that typically uses a continuous filament of a thermoplastic material. The filament may be fed from a filament supply unit to a moving, heated print head, and may be deposited through a print nozzle onto an upper surface of a build plate. Further, the print head may be moved relative to the build plate under control to manufacture a work product that may comprise multiple deposited layers. In some cases, it may also be required to move the work product vertically by a small amount to begin a new layer. In this manner, a three-dimensional object may be produced out of the thermoplastic material.

Further, the build plate is a part of a print bed assembly. The print bed assembly may also comprise a mounting base, such as a stage, and a carrier plate. The print bed assembly may be vertically movable to allow a movement of the work product relative to the print head. The build plate may be removably arranged on the carrier plate. In order to ensure reliable printing on the build plate, the build plate may have to be aligned and fixed in all directions, for e.g., an X-direction, a Y-direction, and a Z-direction with a desired accuracy. The build plate may be removably coupled to the carrier plate using clamps, a vacuum-based coupling means, or a magnet-based coupling means.

Conventionally, when the build plate is to be arranged on the carrier plate, the build plate has to be disposed at a shallow insertion (i.e. positioning) angle with respect to the carrier plate. Such shallow insertion angles may allow insertion of the build plate when clamps or other such fixing elements are being used for coupling the build plate with the carrier plate at the rear end.

However, when the build plate is magnetically coupled with the carrier plate, such shallow insertion angles may be cumbersome and may prevent convenient insertion of the build plate. More particularly, for magnetically-held flexible build plates, if the build plate is held at a shallow insertion angle, magnetic forces acting on the build plate may pull the build plate onto the carrier plate without proper alignment, causing friction that may be hard to overcome by users. Accordingly, such shallow insertion angles may lengthen insertion time for magnetically-held build plates as users may have to put additional efforts and focus for correct placement of the build plate. In some cases, such shallow insertion angles may cause incorrect placement of the build plate on the carrier plate. Overall, this phenomenon may have an undesirable effect on a usability, an efficiency, and a reliability of the additive manufacturing system.

### SUMMARY OF THE INVENTION

The aim of the present invention is to provide a new and improved print bed assembly for an additive manufacturing system. The print bed assembly may comprise multiple components that may support a work product being formed by the additive manufacturing system.

According to a first aspect of the present invention, there is provided a print bed assembly for an additive manufacturing system. The print bed assembly comprises a stage. The print bed assembly also comprises a carrier plate arranged on the stage. The carrier plate comprises an upper surface extending in an X-direction and a Y-direction perpendicular to the X-direction. The print bed assembly further comprises a support structure arranged on the stage and comprising a straight edge extending in the X-direction. The print bed assembly comprises a build plate to be placed on the carrier plate. The print bed assembly also comprises at least one abutment arranged on the stage and spaced apart from the straight edge of to the support structure. The at least one abutment is arranged for limiting movement of the build plate relative to the carrier plate in the Y-direction when the build plate is placed (by a user, or a robot) on the straight edge of the support structure at an angle relative to the upper surface of the carrier plate.

The abutments may function as guiding members during a movement of the build plate from the first state to the second state. The at least one abutment and the support structure may allow easier insertion and coupling of the build plate with the carrier plate. Further, the build plate may be disposed at the higher angle while inserting the build plate which may allow easier handling of the build plate during insertion, thereby improving user experience. The increased angle between the build plate and the carrier plate is specifically advantageous for magnetically held build plates. More particularly, due to the increased angle, a user may not have to put additional efforts to overcome frictional forces between the carrier plate and the build plate that may be caused due to a magnetic pull between the build plate and the carrier plate. Further, the at least one abutment may provide instant alignment of the build plate in the Y-direction. Moreover, a design of the abutment may allow easy disengagement and engagement of the build plate with the abutment.

The print bed assembly described herein may be user-friendly and reliable in operation. Further, the print bed assembly described herein may also improve a usability and an efficiency of the additive manufacturing system. It is noted that the invention is also advantageous in additive manufacturing system having build plates that are not magnetically-held onto the carrier, such as glass plates or metal plates being placed on a carrier plate without magnets in it.

In an embodiment, the print bed assembly further comprises at least one X-alignment structure arranged to align the build plate relative to the carrier plate in the X-direction. The at least one X-alignment structure may allow easier insertion of the build plate by providing instant alignment in the X-direction. Further, when the build plate is in the second state, the at least one X-alignment structure may also fix the build plate in the X-direction to prevent any movement of the build plate in the X-direction.

In an embodiment, the at least one X-alignment structure comprises one or more pins extending from the stage up to a level higher than a level of the upper surface of the carrier plate. In such an embodiment, when the build plate is in the second state, the at least one X-alignment structure may prevent any movement of the build plate in the X-direction. Further, the pins may have a simple design, may be easy to incorporate, and may be cost-effective to manufacture.

In an embodiment, the at least one X-alignment structure comprises one or more profiles extending from the stage up to a level higher than the level of the upper surface of the carrier plate. In such an embodiment, when the build plate is in the second state, the at least one X-alignment structure may prevent any movement of the build plate in the X-direction. Further, the one or more profiles may have a simple design, may be easy to incorporate, and may be cost-effective to manufacture.

In an embodiment, the at least one abutment comprises one or more profiles extending from the stage up to a level higher than the level of the upper surface of the carrier plate. In such an embodiment, when the build plate is in the second state, the at least one Y-alignment structure may prevent any movement of the build plate in the Y-direction. Further, the one or more profiles may have a simple design, may be easy to incorporate, and may be cost-effective to manufacture.

In an embodiment, the at least one abutment comprises one or more pins extending from the stage up to a level higher than the level of the upper surface of the carrier plate. In such an embodiment, when the build plate is in the second state, the at least one Y-alignment structure may prevent any movement of the build plate in the Y-direction. Further, the pins have a simple design, may be easy to incorporate, and may be cost-effective to manufacture.

In an embodiment, the build plate comprises one or more cut-outs at its rear side to receive the one or more pins. In the first state of the build plate, the one or more cut-outs may allow receipt and engagement of the pins with the build plate for alignment in the Y-direction.

Further, in the second state of the build plate, the one or more cut-outs may still receive the pins to prevent any movement of the build plate in the Y-direction. Moreover, based on a location of the one or more cut-outs and a location of the pins, the one or more cut-outs may engage with the pins to further align the build plate in the X-direction when the build plate is in the first state and to prevent any movement of the build plate in the X-direction when the build plate is in the second state.

In an embodiment, at least one of the one or more cut-outs has a V-shape and at least another cut-out has a U-shape. When the build plate is in the first state, the V-shape cut-out together with a corresponding pin may align the build plate in the Y-direction as well as the X-direction. When the build plate is in the second state, the V-shape cut-out together with a corresponding pin may prevent any movement of the build plate in the Y-direction as well as the X-direction. Further, when the build plate is in the second state, the U-shape cut-out together with the corresponding pin may prevent rotation of the build plate along a horizontal plane.

In an embodiment, each of the one or more pins comprises a body portion and a head portion. The head portion of the pin is configured to lock with the build plate when the build plate is arranged on the carrier plate. When the build plate is in the second state, the head portion may fix the build plate in a Z-direction, thereby providing an additional locking feature.

In an embodiment, the support structure is separate from the carrier plate. For example, the support structure may be a separate component spaced apart from the carrier plate.

In an embodiment, the support structure is an integral part of the carrier plate. For example, the straight edge of the support structure may resemble a top edge at the rear side of the carrier plate.

In an embodiment, the build plate comprises a metal flexible plate, and the carrier plate comprises one or more magnets. In such an embodiment, it may be particularly advantageous to dispose the build plate at the higher angle in relation to the carrier plate so as to minimize the effects of the magnetic pull between the build plate and the carrier plate.

In an embodiment, the build plate comprises two extensions at a rear side of the build plate, and wherein the carrier plate comprises two slopes for guiding the extensions during placement of the build plate onto the carrier plate. The slopes help a user to position the build plate build and as such provide for a more ergonomic handling of the build plate. It is noted that the build plate may comprise the extensions without the carrier plate having the slopes. It is also noted that the build plate may comprise a different number of extensions at the rear side, such as one, three, four or even more.

According to a second aspect, there is provided an additive manufacturing system comprising the print bed assembly as described above. Due to the specially designed print bed assembly, the additive manufacturing system may exhibit improved usability, reliability, and efficiency. The additive manufacturing system may be a fused filament fabrication (FFF) system. However, the invention is not limited to FFF systems. For example, the additive manufacturing system may be a pellet extruder printing system, a 3D inkjet printing system, a selective laser sintering (SLS) system, etcetera.

### BRIEF DESCRIPTION OF THE DRAWINGS

These and other aspects of the invention are apparent from and will be elucidated with reference to the embodiments described hereinafter. In the drawings, FIG. 1 schematically shows a front view of an additive manufacturing system according to an embodiment of the present invention;

FIG. 2 schematically shows a perspective view of a print bed assembly associated with the additive manufacturing system of FIG. 1 in which a build plate of the print bed assembly is still distant from the carrier plate;

FIG. 3A schematically shows a side cross-sectional view of a portion of the print bed assembly of FIG. 2 in which the build plate is placed into a first state;

FIG. 3B is a detailed view of a part of FIG. 3A;

FIG. 4 schematically shows a perspective view of a Y-alignment structure according to an embodiment of the present invention;

FIG. 5 schematically shows a perspective view of the print bed assembly of FIG. 2 with the build plate laid down onto the carrier plate;

FIG. 6 schematically shows a perspective view of a Y-alignment structure according to an embodiment of the present invention;

FIG. 7 schematically shows a top view of a build plate according to an embodiment of the present invention;

FIG. 8A schematically shows a perspective view of a print bed assembly according to another embodiment of the present invention;

FIG. 8B schematically shows a side cross-sectional view of a portion of the print bed assembly of FIG. 8A;

FIG. 9 schematically shows a perspective view of a print bed assembly having two X-alignment structures and two Y-alignment structures according to yet another embodiment of the present invention;

FIG. 10 schematically shows a perspective view of a print bed assembly having two X-alignment structures and two Y-alignment structures according to an embodiment of the present invention;

FIG. 11 schematically shows a perspective view of a print bed assembly having two X-alignment structures and one Y-alignment structure according to another embodiment of the present invention;

FIG. 12A schematically shows a perspective view of a print bed assembly having two X-alignment structures, one Y-alignment structure, and a separate support structure according to yet another embodiment of the present invention;

FIG. 12B shows a side cross-sectional view of part of the embodiment of FIG. 12A;

FIG. 13 schematically shows a perspective view of a print bed assembly having a Y-alignment structure and a separate support structure according to an embodiment of the present invention;

FIG. 14A schematically shows a perspective view of the print bed assembly having a Y-alignment structure, a separate support structure, and a locking member according to another embodiment of the present invention;

FIG. 14B shows a side cross-sectional view of part of the embodiment of FIG. 14A;

FIG. 15A schematically shows a side view of part of an embodiment wherein the build plate is in the first state S1, and

FIG. 15B schematically shows a side view of part of the embodiment of FIG. 15A wherein the build plate is in the second state S2.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

FIG. 1 schematically shows a front view of an additive manufacturing system 100, according to an embodiment of the present invention. The additive manufacturing system 100 may be a fused filament fabrication (FFF) system. However, the invention is not limited to FFF systems. For example, the additive manufacturing system 100 may be a pellet extruder printing system, a 3D inkjet printing system, a selective laser sintering (SLS) system, etcetera. The additive manufacturing system 100 comprises a housing 102 and a print head 104 arranged in the housing 102. The housing 102 may be generally box shaped and defines a hollow space 108 also interchangeably referred to as a build chamber 108. A user interface 110 is arranged at a front side of the housing 102. The user interface 110 may comprise a display for displaying information on a print job and one or more input devices for receiving user instructions. The additive manufacturing system 100 is arranged to build parts/components in a layer-by-layer manner using information from a software model, such as, a computer-aided design (CAD) model. The print head 104 may comprise at least one extruder (not shown) that may receive a consumable material, such as, a filament 106. The filament 106 may comprise a thermoplastic material. The consumable material may be melted by the at least one extruder and the molten consumable material may be utilized to produce the parts/components. The print head 104 may be movable along an X-direction and/or a Y-direction.

The additive manufacturing system 100 also comprises a print bed assembly 200. The additive manufacturing system 100 may deposit the consumable material from the print head 104 onto the print bed assembly 200 in the layer-by-layer manner to form a three-dimensional (3D) printed object. The print bed assembly 200 is received within the hollow space 108 of the housing 102. Further, the print bed assembly 200 may be vertically spaced apart from the print head 104. The print bed assembly 200 may be movable along a Z-direction. The X-direction, the Y-direction, and the Z-direction are mutually perpendicular to each other. In other examples, the print bed assembly 200 may be stationary and the print head 104 may be movable along the Z-direction in addition to the X-direction and/or the Y-direction. In a further embodiment, the print head 104 is movable in the Z-direction while the print bed assembly 200 is movable in the X and Y-directions. It should be noted that the additive manufacturing system 100 may comprise any arrangement of components that may synchronously operate to manufacture the 3D printed object, without any limitations.

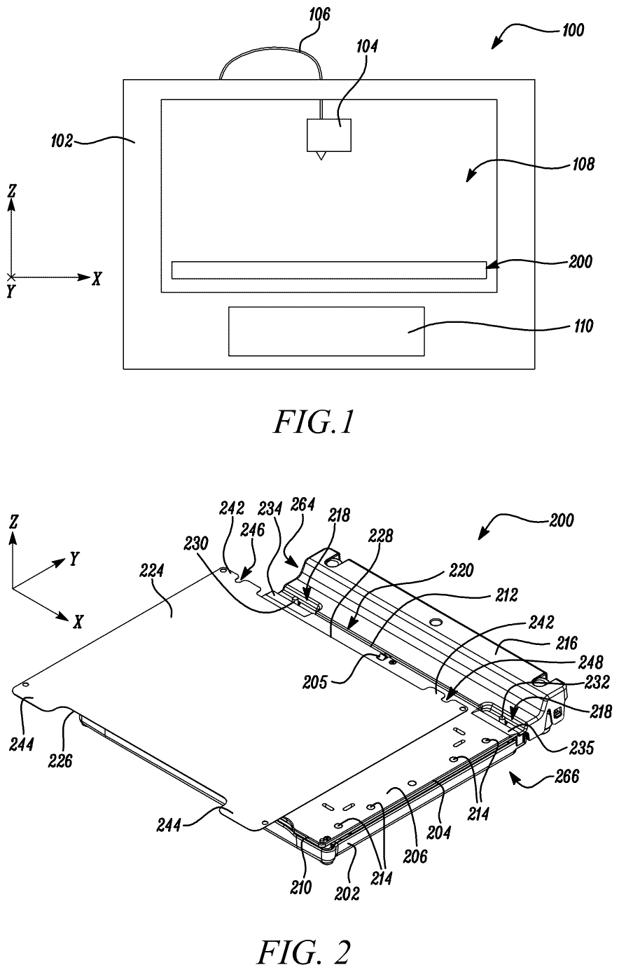

FIG. 2 schematically shows a perspective view of the print bed assembly 200 for the additive manufacturing system 100 (see FIG. 1) according to an embodiment. The print bed assembly 200 comprises a stage 202. The stage 202 may be embodied as a base of the print bed assembly 200. It should be noted that the stage 202 may comprise any arrangement of elements that may allow mounting of one or more components of the print bed assembly 200. The stage 202 may be movable in order to effectuate a movement of the print bed assembly 200.

Specifically, the stage 202 may be coupled to one or more driving means to vertically move the stage 202. The stage 202 may also be guided by one or more rods (not shown) extending through holes (not shown) at a rear side of the stage 202. In the embodiment of FIG. 2, the stage 202 is generally rectangular in shape. Alternatively, the stage 202 may be realized in any other shape, such as, a square shape, without any limitations. Further, the stage 202 may be made of any suitable material, such as, a metal. In an example, the stage 202 may comprise one or more fastening elements (not shown) that may movably couple the stage 202 with the housing 102 (see FIG. 1). The stage 202 defines opposing ends 264, 266 spaced apart from each other along the X-direction. The print bed assembly 200 further comprises a carrier plate 204 arranged on the stage 202. The carrier plate 204 may be spaced apart from the stage 202 in the Z-direction. The carrier plate 204 may be coupled to the stage 202 via a number of mechanical fasteners (not shown). The mechanical fasteners may comprise a screw, a bolt, a pin, and the like. The mechanical fasteners may be adjustable in height so as to correctly level the carrier plate 204 and thus the build plate 224 when placed on the carrier plate. The carrier plate 204 comprises an upper surface 206 extending in the X-direction and the Y-direction perpendicular to the X-direction. Further, the carrier plate 204 defines a front side 210 and a rear side 212, each of which extend in the X-direction. In the embodiment of FIG. 2, the carrier plate 204 is generally rectangular in shape. Alternatively, the carrier plate 204 may have any other shape, such as, a square shape. The carrier plate 204 may be made of any suitable material comprising, but not limited to, metals, ceramics, and polymers. In the example of FIG. 2 a build plate detection sensor 205 is arranged in a cavity of the carrier plate 204 at the rear edge 212.

The print bed assembly 200 further comprises a build plate 224 to be placed on the carrier plate 204. During printing, the consumable material may be deposited on the build plate 224 to form the 3D printed object. In FIG. 2, the build plate 224 is not yet arranged on the carrier plate 204. In the embodiment of FIG. 2, the build plate 224 comprises a metal flexible plate. However, the build plate 224 may be made of any other suitable material. For example, any type of transparent or non-transparent glass or metal may be used to manufacture the build plate 224.

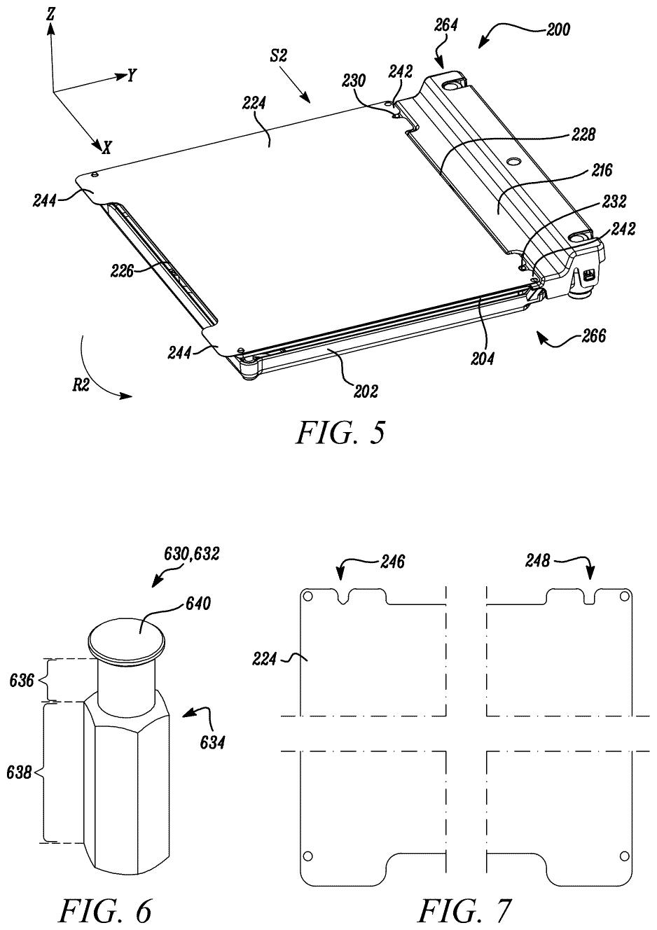

In the embodiment of FIG. 2, the build plate 224 comprises a substantially rectangular plate with rounded corners. Alternatively, the build plate 224 may comprise any other shape suitable for building an object on. Preferably, the dimensions of the build plate 224 are similar to the dimensions of the carrier plate 204, such that when the build plate 224 is placed on the carrier plate 204, at least a front edge 226 and a rear edge 228 of the build plate 224 are aligned with the respective front and rear sides 210, 212 of the carrier plate 204. In this way, the build plate 224 is fully supported. When the build plate 224 is placed on the carrier plate 204 (see e.g. FIG. 5), the build plate 224 contacts the upper surface 206 of the carrier plate 204. In an example, a separate adhesive sheet (not shown) may be placed on the build plate 224 on which the 3D printed object may be formed.

The print bed assembly 200 also comprises at least one abutment 230, 232 arranged on the stage 202. In the embodiment of FIG. 2, the print bed assembly 200 comprises two abutments 230, 232 (also referred to as Y-alignment structures). Alternatively, the print bed assembly 200 may comprise a single abutment or more than two abutments, for example, four abutments.

Further, each abutment 230, 232 is coupled to the stage 202 herein. Each abutment 230, 232 is located behind the rear side of the carrier plate 204 when looking in the Y-direction. It is noted that in this embodiment, the abutments do not touch the carrier plate 204.

The abutment 230 is substantially similar in design to the abutment 232. The abutments 230, 232 are arranged to align the build plate 224 relative to the carrier plate 204 in the Y-direction. In the embodiment of FIG. 2, the abutments 230, 232 also align the build plate 224 relative to the carrier plate 204 in the X-direction. Thus, the abutments 230, 232 in this case may be referred to as “XY-alignment structures” as they align the build plate 224 in each of the X-direction and the Y-direction. The abutments 230, 232 may allow easier installation of the build plate 224 by providing instant alignment of the build plate 224 in the Y-direction as well as the X-direction.

As shown in FIG. 2, the carrier plate 204 in this embodiment comprises one or more magnets 214. Specifically, the carrier plate 204 comprises a plurality of magnets 214 spaced apart from each other in the X-direction and the Y-direction. The magnets 214 in the carrier plate 204 may allow coupling of the build plate 224 to the carrier plate 204. The magnets 214 are received within the carrier plate 204. Specifically, the carrier plate 204 defines a plurality of holes (not shown). Each hole is configured to receive at least a portion of a corresponding magnet 214 therein. It should be noted that the build plate 224 may be coupled with the carrier plate 204 using other fastening means, such as, clamps, mechanical fasteners, vacuum coupling, and the like, without any limitations thereto. In an example, in addition to the magnetic coupling, the print bed assembly 200 may comprise one or more fasteners (not shown) that may couple the build plate 224 with the carrier plate 204. It should be noted that the Y-alignment structures 230, 232 along with the support structure 220 may allow easier insertion of the build plate 224 especially when the build plate 224 is metallic and the carrier plate 204 comprises the magnets 214. Moreover, a design of the Y-alignment structures 230, 232 may allow easy disengagement and engagement of the build plate 224 with the build plate 224.

Further, the print bed assembly 200 comprises a print bed cover 216. The print bed cover 216 is coupled to the stage 202 at the rear side. The print bed cover 216 defines a pair of slots 218 spaced apart from each other along the X-direction. The pair of slots 218 are defined at opposing ends 264, 266 of the stage 202. The slots 218 are substantially rectangular in shape. In an example, the print bed cover 216 may be made of polymer.

The print bed assembly 200 may further comprise a heating element (not shown) arranged under or in the carrier plate 204. The heating element may maintain a temperature of one or more components of the print bed assembly 200, such as the carrier plate 204 or the build plate 224, at a desired temperature level. The heating element may be disposed between the carrier plate 204 and the stage 202.

In this embodiment, the build plate 224 comprises a pair of rear flaps 242. The rear flaps 242 extend from the rear edge 228 of the build plate 224 along the Y-direction. The flaps 242 are also referred to as build plate extensions 224. When the build plate 224 is placed on the carrier plate 204, the rear flaps 242 are received in the slots 218 defined by the print bed cover 216. The rear flaps 242 are substantially rectangular in shape.

The build plate 224 further comprises a pair of handles 244 extending from the front edge 226 of the build plate 224 along the Y-direction. The handles 244 are substantially rectangular in shape. It should be noted that the handles 244 may include any other shape or design. For example, each handle 244 may define an opening to facilitate holding of the build plate 224.

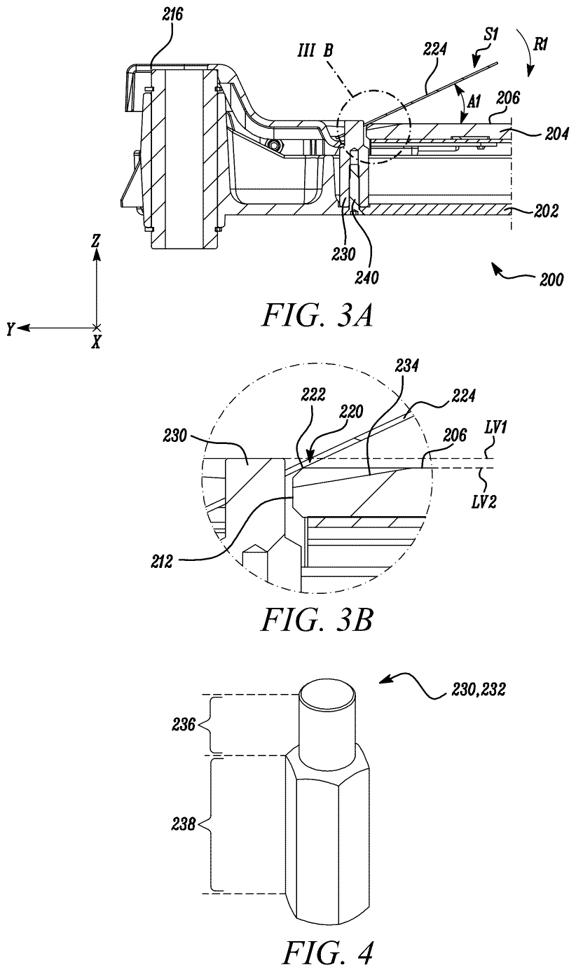

Further, the build plate 224 comprises one or more cut-outs 246, 248 to receive the one or more pins 230, 232. Specifically, the build plate 224 comprises two cut-outs 246, 248. Each cut-out 246, 248 at least partially receives a corresponding pin 230, 232 in each of a first state S1 (as illustrated in FIG. 3A) and a second state S2 (as illustrated in FIG. 5) of the build plate 224.

Thus, the cut-outs 246, 248 allow an engagement of the pins 230, 232 with the build plate 224 in each of the first state S1 (also referred to as tilted state S1) and the second state S2 (also referred to as final state S2) of the build plate 224. The one or more cut-outs 246, 248 may have all kinds of shapes, such as a V-shape or a U-shape. In the embodiment of FIG. 2, the first cut-out, e.g. cut out 246, has a V-shape and the second cut-out, e.g. cut-out 248, has a U-shape.

FIG. 3A shows a cross sectional side view of the print bed assembly 200 of FIG. 2 across one of the Y-alignment structures 230. In FIG. 3A the build plate 224 is disposed in a first state S1 in which the build plate 224 is placed against the alignment structures 230, 232 and makes an angle A1 relative to the upper surface 206 of the carrier plate 204. If the build plate 224 is positioned (i.e. by a user) in the first state S1, the build plate 224 should touch all the Y-alignment structures 230, 232. Next, the build plate 224 can be moved to a second state S2 (as illustrated in FIG. 5). The build plate 224 is in the second state S2 when the build plate 224 is placed flat on the carrier plate 204. The build plate 224 can be moved from the first state S1 to the second state S2 by way of lowering (i.e. rotating, see R1) the build plate 224 while keeping contact with a straight edge (see 222 in FIG. 3B) at the rear side of the carrier plate 204, which rear side in this case is acting as a support structure. If the build plate 224 is placed down onto the upper surface 206 of the carrier plate 204 correctly, the build plate 224 still touches the at least one Y-alignment structure 230, 232. This results in an optimal alignment of the build plate 224 relative to the carrier plate 204, at least in the Y-direction. No further adjustment of the build plate 224 is needed once the build plate 224 is laid down on the carrier plate 204.

FIG. 3B is a detailed view of part of FIG. 3A. As shown in FIG. 3B, the print bed assembly 200 further comprises a support structure 220 arranged on the stage 202 and comprising a straight edge 222 extending in the X-direction. The at least one Y-alignment structure 230, 232 is arranged on the stage 202 next to the support structure 220. Specifically, the at least one Y-alignment structure 230, 232 is arranged adjacent to the support structure 220 along the Y-direction. In the embodiment of FIG. 2, the support structure 220 is an integral part of the carrier plate 204. Specifically in this case, the rear edge 212 of the carrier plate 204 is used to support the build plate in the first state S1.

Further, the build plate 224 is shown in the first state S1 in FIGS. 3A and 3B. In the first state S1, when the build plate 224 is placed on the support structure 220 at an angle A1 relative to the upper surface 206 of the carrier plate 204, the build plate 224 touches the straight edge 222 of the support structure 220 and the at least one Y-alignment structure 230, 232 (see FIG. 2). It should be noted that only the Y-alignment structure 230 is visible in FIGS. 3A and 3B, however, the build plate 224 also touches the Y-alignment structure 232 in the first state S1 thereof. Further, the support structure 220 provides a rotational hinge point about which the build plate 224 can be moved in the direction R1 for placement of the build plate 224 on the carrier plate 204. Moreover, the straight edge 222 of the support structure 220 may define an axis about which the build plate 224 may rotate in the direction R1. It should be noted that preferably each Y-alignment structure 230, 232 stays in constant contact with the build plate 224 during the rotation of the build plate 224 along the direction R1. Thus, the Y-alignment structures 230, 232 may function as guiding members during the rotation of the build plate 224.

It is noted that in this embodiment, two slopes 234, 235 are arranged in the carrier plate 204 for guiding the flaps 242 during installing the build plate 224. Due to the limited length of the flaps 242 in this example, the flaps will get detached from the slopes 234, 235 once the build plate 224 contacts the abutments 230 in the tilted state S1, see also FIG. 3B. This is because in state S1, the middle section at rear side of the build plate 224 (i.e. region between the flaps 242) will come into contact with the top edge 222 at the rear side 212 of the carrier plate 204, which results in a lifting of the flaps relative to the slopes of the carrier plate. So, in the situation S1 shown in FIG. 3B the flaps 242 abut against the abutments 230, 232, while the build plate 224 rests on the top edge 222 of the carrier plate 206 at the back side.

Since the Y-alignments are arranged next to the carrier plate 204, a space behind the carrier plate 204 is used to insert/place the build plate under an angle. Depending on the distance between the Y-alignment and the carrier plate 204, and the thickness of the build plate 224, the build plate 224 can be inserted under a range of angles A1. Practically, the angle A1 of the build plate 224 relative to the upper surface 206 of the carrier plate 204 lies in a range of 5 degrees to 80 degrees. In an example, the angle A1 of the build plate 224 relative to the upper surface 206 may lie in a range of 10 degrees to 45 degrees. It is noted that the higher angle A1 while insertion of the build plate 224 may allow easier handling of the build plate 224 when the build plate 224 is being rotated in the direction R1. The increased angle A1 between the build plate 224 and the carrier plate 204 is specifically advantageous for magnetically held build plates. More particularly, due to the increased angle A1, users may not have to put additional efforts to overcome frictional forces between the carrier plate 204 and the build plate 224 that may be caused due to a magnetic pull between the build plate 224 and the carrier plate 204.

As can be seen from FIG. 3B, the at least one Y-alignment structure 230, 232 comprises one or more pins extending from the stage 202 up to a level LV1 higher than a level LV2 of the upper surface 206 of the carrier plate 204. In other words, the at least one Y-alignment structure 230, 232 extends higher than the upper surface 206 of the carrier plate 204 relative to the Z-direction. The levels LV1 and LV2 are defined in relation to the stage 202 along the Z-direction. As the level LV1 is higher than the level LV2, the build plate 224 may be in constant contact with the at least one Y-alignment structure 230, 232 even when the build plate 224 is in the second state S2.

The Y-alignment structures 230, 232 are interchangeably referred to as the pins 230, 232. The pin 230, 232 comprises a first section 236 and a second section 238 fixedly coupled to the first section 236. The second section 238 is removably coupled with the stage 202 by a fastener 240. In another example, the second section 238 may be integral with the stage 202. Further, the first section 236 engages with the build plate 224 in each of the first state S1 and the second state S2 of the build plate 224.

It is noted that due to the fact that the Y-alignment structures are arranged next to (i.e. behind) the carrier plate 204 (and not on top of the carrier plate like in the known devices), the edge of the carrier plate 204 can be used to hinge/rotate the build plate 204 from state S1 to state S2. During this rotational movement, when a sufficient minimal force is applied by a user or robot, the build plate 224 keeps contact with the Y-alignment structures; so also in state S2 the build plate is fully aligned at least in the Y-direction.

FIG. 4 schematically shows a perspective view of a Y-alignment structure 230, 232 according to an embodiment of the present invention. As shown in FIG. 4, a first section 236 of the structure 230, 232 is cylindrical in shape. Further, a second section 238 is hexagonal in shape. The pin 230, 232 has a height which results in a top of the pin to be above the top surface 206 of the carrier plate 204. This avoids the build plate 224 from moving over the pins 230, 232 in the state S2, in case a user would use too much force.

FIG. 5 shows a perspective view of the assembly 200 in the second state S2 wherein the build plate 224 is placed onto the carrier plate 204. In this embodiment, the build plate 224 fully covers the carrier plate 204. Preferably, the build plate 224 has a dimension in the X-direction equal, or substantially equal to the carrier plate 204, as is appreciated by the skilled person.

In the embodiment of FIG. 5, the cut-out 246 has a V-shape and the cut-out 248 has a U-shape. In the first state S1 (see also FIG. 3A), the cut-out 246 and the pin 230 together align the build plate 224 in the X-direction and the Y-direction. In the second state S2, the cut-out 246 and the pin 230 may prevent any movement of the build plate 224 in the X-direction as well as the Y-direction. Further, in the first state S1, the cut-out 248 and the pin 232 together align the build plate 224 in the X-direction and the Y-direction. Moreover, in the second state S2, the cut-out 248 and the pin 232 together limit a rotation of the build plate 224 in a horizontal plane (i.e., the X-Y plane) along a direction R2.

FIG. 6 illustrates another design of at least one Y-alignment structure 630, 632 that may be used with the print bed assembly 200 (see FIGS. 2 and 3). Each Y-alignment structure 630, 632 is embodied as a pin herein. The Y-alignment structures 630, 632 are interchangeably referred to as the pins 630, 632. The Y-alignment structures 630, 632 are substantially similar to the Y-alignment structures 230, 232 described in FIG. 4 5 in terms of functionality. However, each of the one or more pins 630, 632 comprises a body portion 634 and a head portion 640. The body portion 634 comprises a first section 636 and a second section 638 fixedly coupled to the first section 636. The second section 638 is configured to couple with the stage 202 (see FIGS. 2 and 3A). Further, the first section 636 engages with the build plate 224 (see FIGS. 2 and 3A) in each of the first state S1 (see FIG. 3A) and the second state S2 (see FIG. 5) of the build plate 224. As shown in FIG. 6, the first section 636 is cylindrical in shape. Further, the second section 638 is hexagonal in shape.

Further, the head portion 640 is fixedly coupled to the second section 638. The head portion 640 is circular in shape. The head portion 640 of the corresponding pins 630, 632 is configured to lock with the build plate 224 when the build plate 224 is arranged on the carrier plate 204 (see FIGS. 3A and 5). When the build plate 224 is in the second state, the head portion 640 may prevent any movement of the build plate 224 along the Z-direction (see FIGS. 3A and 5). Thus, the head portion 640 provides an additional locking feature for the build plate 224. It should be noted that the designs of the Y-alignment structures 230, 232, 630, 632 as explained in relation to FIGS. 4 and 6 are exemplary in nature, and the Y-alignment structures 230, 232, 630, 632 may comprise any other design. The Y-alignment structures 230, 232, 630, 632 may be made of any material comprising, but not limited to, metals or ceramics. In an example, the Y-alignment structures 230, 232, 630, 632 may be made from a sheet metal. The Y-alignment structures 230, 232, 630, 632 have a simple design, are easy to incorporate, and can be cost-effective to manufacture.

FIG. 7 shows a top view of the build plate 224. The build plate 224 comprises a pair of cut-outs 246, 248, wherein cut-out 246 has a V-shape and cut-out 248 has a U-shape. The U-shaped cut-out 248 preferably has a U-shape wherein the U has a flat bottom line, or at least a partly flat bottom line. This flat part extends in the X direction, when the build plate 224 is placed correctly (i.e. aligned) on the carrier plate 204. In such an embodiment, each cut-out 246, 248 and a corresponding Y-alignment structure 230, 232 (see FIGS. 2, 3, and 5) will help to align the build plate 224 in the Y-direction. Further, cut-out 246 and its corresponding Y-alignment structure 230 will restrict any movement of the build plate 224 in the X-direction as well.

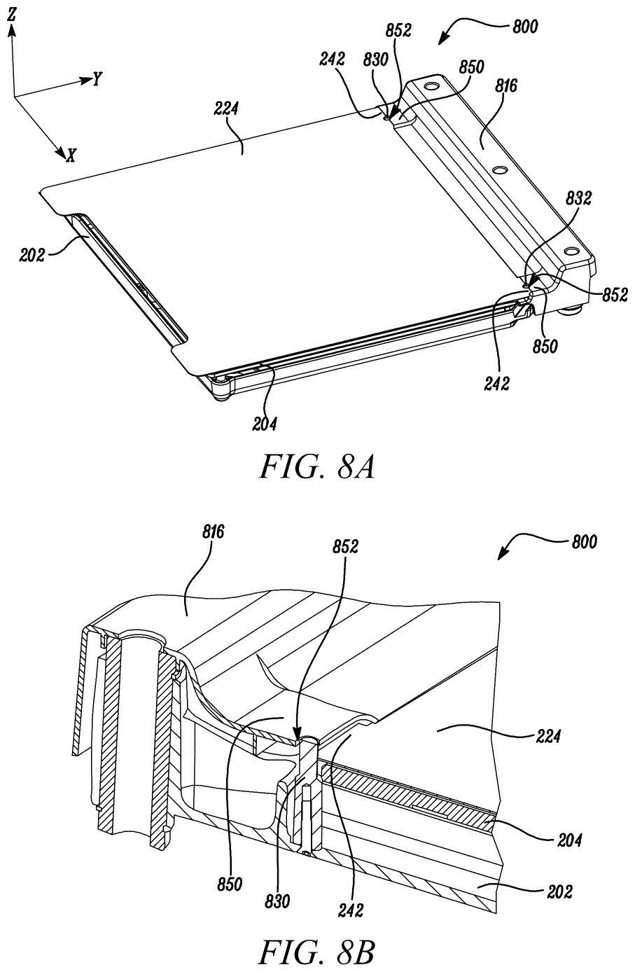

FIGS. 8A and 8B illustrate another embodiment of the present invention. FIG. 8A illustrates a print bed assembly 800 that is substantially similar to the print bed assembly 200 (see FIGS. 2, 3, and 5). The print bed assembly 800 comprises a stage 202, a carrier plate 204, a build plate 224 having rear flaps 242, and a support structure 220 comprising a straight edge 222 similar to those described above. In the embodiment of FIG. 8A, the print bed assembly 800 comprises a print bed cover 816. The print bed cover 816 comprises a pair of cover members 850. Each cover member 850 is configured to cover a corresponding rear flap 242 when the build plate 224 is arranged on the carrier plate 204. Further, each cover member 850 defines an opening 852. Each opening 852 is configured to receive, at least partially, a corresponding Y-alignment structure 830, 832 therein. The Y-alignment structures 830, 832 are embodied as pins herein. The Y-alignment structures 830, 832 are substantially similar to the Y-alignment structures 230, 232 in terms of shape and functionality. However, in this embodiment, a height (see FIG. 8B) of each Y-alignment structure 830, 832 is greater than the height of the Y-alignment structures 230, 232 (see FIG. 4).

FIG. 8B illustrates a cross-sectional view of a portion of the print bed assembly 800. As shown in FIG. 8B, the rear flap 242 is covered by the print bed cover 816. Further, in this embodiment, the Y-alignment structures 830, 832 (see FIG. 8A) along with the cover members 850 fully enclose the rear flaps 242, thereby preventing the build plate 224 from slipping off by improper handling by the user. This may increase reliability of the print bed assembly 800. In an example, the print bed cover 816 may be made of polymer. Accordingly, the print bed cover 816 may be suitably spaced apart from any component of the print bed assembly 800, such as, the build plate 224 that heats up during operation thereof.

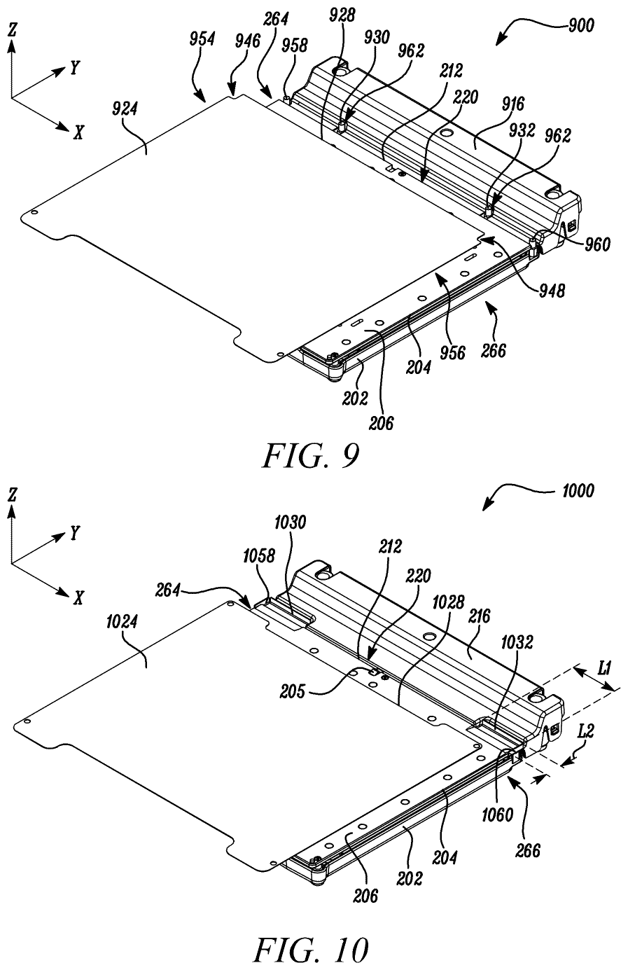

FIG. 9 illustrates a print bed assembly 900, according to an embodiment of the present invention. The print bed assembly 900 of FIG. 9 is substantially similar to the print bed assembly 200 of FIGS. 2, 3, and 5 in terms of functionality. The print bed assembly 900 comprises a stage 202, a carrier plate 204 having an upper surface 206, and a support structure 220 comprising a straight edge 222 similar to those described above. The print bed assembly 900 also comprises a build plate 924 to be placed on the carrier plate 204. The build plate 924 differs from the build plate 224 (see FIGS. 2, 3, and 5). Specifically, the build plate 924 comprises a pair of cut-outs 946, 948 disposed at opposing ends 954, 956 of the build plate 924. The cut-outs 946, 948 are substantially rectangular in shape. The build plate 224 also defines a rear edge 928 extending between the pair of cut-outs 946, 948 in the X-direction. It should be noted that details related to the positioning of the build plate 224 of the print bed assembly 200 in the first and second states S1, S2 (as illustrated and explained in relation to FIGS. 3 and 2, respectively) are equally applicable to a positioning of the build plate 924 of the print bed assembly 900.

Further, the print bed assembly 900 comprises two Y-alignment structures 930, 932. In the embodiment of FIG. 9, the Y-alignment structures 930, 932 align the build plate 924 relative to the carrier plate 204 in the Y-direction. Specifically, in a first state (i.e., during an insertion of the build plate 924) of the build plate 924, the Y-alignment structures 930, 932 aligns the build plate 924 in the Y-direction. The Y-alignment structures 930, 932 engage with the rear edge 928 of the build plate 924 for aligning the build plate 924 in the Y-direction. Moreover, in a second state (i.e., when the build plate 924 is placed on the carrier plate 204) of the build plate 924, the Y-alignment structures 930, 932 prevent any movement of the build plate 924 along the Y-direction. The Y-alignment structures 930, 932 are embodied as and interchangeably referred to as the pins 930, 932. The Y-alignment structures 930, 932 are substantially similar to the Y-alignment structures 230, 232 described in FIGS. 3 and 4 in terms of design and functionality. Alternatively, the Y-alignment structures 930, 932 may be substantially similar in design to the Y-alignment structures 630, 632 explained in relation to FIG. 6.

Further, the print bed assembly 900 comprises at least one X-alignment structure 958, 960 arranged to align the build plate 924 relative to the carrier plate 204 in the X-direction. Specifically, the print bed assembly 900 comprises two X-alignment structures 958, 960 that align the build plate 924 in the X-direction. The X-alignment structures 958, 960 are spaced apart from each other in the X-direction and disposed at the respective opposing ends 264, 266 of the stage 202. In the first state of the build plate 924, the X-alignment structures 958, 960 engage with the corresponding cut-outs 946, 948 in the build plate 924 to align the build plate 924 in the X-direction. Moreover, in the second state of the build plate 924, the X-alignment structures 958, 960 may prevent any movement of the build plate 924 along the X-direction.

In the embodiment of FIG. 9, the at least one X-alignment structure 958, 960 comprises one or more pins extending from the stage 202 up to a level higher than the level of the upper surface 206 of the carrier plate 204. In other words, the at least one X-alignment structure 958, 960 extends higher than the upper surface 206 of the carrier plate 204 relative to the Z-direction. As the level of the at least one X-alignment structure 958, 960 is higher than the level of the upper surface 206, the build plate 924 may be in contact with the at least one X-alignment structure 958, 960 even when the build plate 924 is in the second state. The X-alignment structures 958, 960 are interchangeably referred to as the pins 958, 960. It should be noted that the X-alignment structures 958, 960 are substantially similar in design to the Y-alignment structures 230, 232 explained in relation to FIGS. 3 and 4. Alternatively, the X-alignment structures 958, 960 may be substantially similar in design to the Y-alignment structures 630, 632 explained in relation to FIG. 6.

Further, when the build plate 924 is in the first state (i.e. tilted state S1), the build plate 924 touches each of the straight edge 222 of the support structure 220, the at least one Y-alignment structure 930, 932, and the at least one X-alignment structure 958, 960. Moreover, when the build plate 924 is in the second state (i.e. flat end state S2), the build plate 924 still touches the at least one Y-alignment structure 930, 932 and the at least one X-alignment structure 958, 960.

The print bed assembly 900 also comprises a print bed cover 916. The print bed cover 916 defines a pair of through-holes 962 that are spaced apart from each other in the X-direction. Each through-hole 962 is configured to receive at least a portion of a corresponding Y-alignment structure 930, 932 to allow attachment of the corresponding Y-alignment structure 930, 932 with the stage 202.

FIG. 10 illustrates a print bed assembly 1000, according to another embodiment of the present invention. The print bed assembly 1000 of FIG. 10 is substantially similar to the print bed assembly 200 of FIGS. 2, 3, and 5 in terms of functionality. The print bed assembly 1000 comprises a stage 202, a carrier plate 204 having an upper surface 206, a print bed cover 216, and a support structure 220 comprising a straight edge 222 similar to those described above. The print bed assembly 1000 also comprises a build plate 1024 to be placed on the carrier plate 204. The build plate 1024 differs from the build plate 224 (see FIGS. 2, 3, and 5). Specifically, the build plate 1024 does not comprise any cut-outs (such as, the cut-outs 246, 248 in the build plate 224). It should be noted that details related to the positioning of the build plate 224 of the print bed assembly 200 in the first and second states S1, S2 (as illustrated and explained in relation to FIGS. 3 and 5, respectively) are equally applicable to a positioning of the build plate 1024 of the print bed assembly 1000.

Further, the print bed assembly 1000 comprises at least one Y-alignment structure 1030, 1032. The at least one Y-alignment structure 1030, 1032 comprises one or more profiles extending from the stage 202 up to a level higher than the level of the upper surface 206 of the carrier plate 204. In other words, the at least one Y-alignment structure 1030, 1032 extends higher than the upper surface 206 of the carrier plate 204 relative to the Z-direction. As the level of the at least one Y-alignment structure 1030, 1032 is higher than the level of the upper surface 206, the build plate 1024 may be in contact with the at least one Y-alignment structure 1030, 1032 even when the build plate 1024 is in the second state S2. The print bed assembly 1000 comprises two Y-alignment structures 1030, 1032 herein. In the embodiment of FIG. 10, each Y-alignment structure 1030, 1032 is embodied as a substantially vertical member extending from the stage 202 in the Z-direction. The Y-alignment structures 1030, 1032 also extend along the X-direction and are disposed at the respective opposing ends 264, 266 of the stage 202. Each Y-alignment structure 1030, 1032 defines a first length L1 along the X-direction. The Y-alignment structures 1030, 1032 are arranged to align the build plate 1024 relative to the carrier plate 204 in the Y-direction. Specifically, in a first state (i.e., during an insertion of the build plate 1024) of the build plate 1024, the Y-alignment structures 1030, 1032 align the build plate 1024 in the Y-direction. Moreover, in a second state (i.e., when the build plate 1024 is placed on the carrier plate 204) of the build plate 1024, the Y-alignment structures 1030, 1032 may prevent any movement of the build plate 1024 along the Y-direction.

Further, the print bed assembly 1000 comprises at least one X-alignment structure 1058, 1060 arranged to align the build plate 1024 relative to the carrier plate 204 in the X-direction. The at least one X-alignment structure 1058, 1060 comprises one or more profiles extending from the stage 202 up to a level higher than the level of the upper surface 206 of the carrier plate 204. In other words, the at least one X-alignment structure 1058, 1060 extends higher than the upper surface 206 of the carrier plate 204 relative to the Z-direction. As the level of the at least one X-alignment structure 1058, 1060 is higher than the level of the upper surface 206, the build plate 1024 may be in contact with the at least one X-alignment structure 1058, 1060 even when the build plate 1024 is in the second state. The print bed assembly 1000 comprises two X-alignment structures 1058, 1060 herein. In the embodiment of FIG. 10, each X-alignment structure 1058, 1060 is embodied as a substantially vertical member extending from the stage 202 in the Z-direction. The X-alignment structures 1058, 1060 extend along the Y-direction and are disposed at the respective opposing ends 264, 266 of the stage 202. Further, the X-alignment structures 1058, 1060 are substantially parallel to each other. Moreover, the Y-alignment structures 1030, 1032 are substantially perpendicular to each X-alignment structure 1058, 1060. Each X-alignment structure 1058, 1060 defines a second length L2 along the Y-direction. In the embodiment of FIG. 10, the first length L1 of each Y-alignment structure 1030, 1032 is greater than the second length L2 of each X-alignment structure 1058, 1060.

In the first state, each X-alignment structure 1058, 1060 aligns the build plate 1024 in the X-direction. Moreover, in the second state of the build plate 1024, each X-alignment structure 1058, 1060 prevents any movement of the build plate 1024 along the X-direction. In the embodiment of FIG. 10, the X-alignment structure 1058 and the Y-alignment structure 1030 are manufactured as separate components. Alternatively, the X-alignment structure 1058 and the Y-alignment structure 1030 may be integral and manufactured as a single component. For example, the X-alignment structures 1058 and the Y-alignment structure 1030 may together form an L-shaped XY-alignment structure. Similarly, in the embodiment of FIG. 10, the X-alignment structure 1060 and the Y-alignment structure 1032 are manufactured as separate components. Alternatively, the X-alignment structure 1060 and the Y-alignment structure 1032 may be integral and manufactured as a single component. For example, the X-alignment structure 1060 and the Y-alignment structures 1032 may together form an L-shaped XY-alignment structure.

The Y-alignment structures 1030, 1032 and the X-alignment structures 1058, 1060 may be made of any material comprising, but not limited to, metals or ceramics. In an example, the Y-alignment structures 1030, 1032 and the X-alignment structures 1058, 1060 may be made from a sheet metal. The Y-alignment structures 1030, 1032 and the X-alignment structures 1058, 1060 may have a simple design, may be easy to incorporate, and may be cost-effective to manufacture.

Further, when the build plate 1024 is in the first state S1, the build plate 1024 touches each of the straight edge 222 of the support structure 220, the at least one Y-alignment structure 1030, 1032, and the at least one X-alignment structure 1058, 1060. Moreover, when the build plate 1024 is in the second state S2, the build plate 1024 still touches the at least one Y-alignment structure 1030, 1032 and the at least one X-alignment structure 1058, 1060.

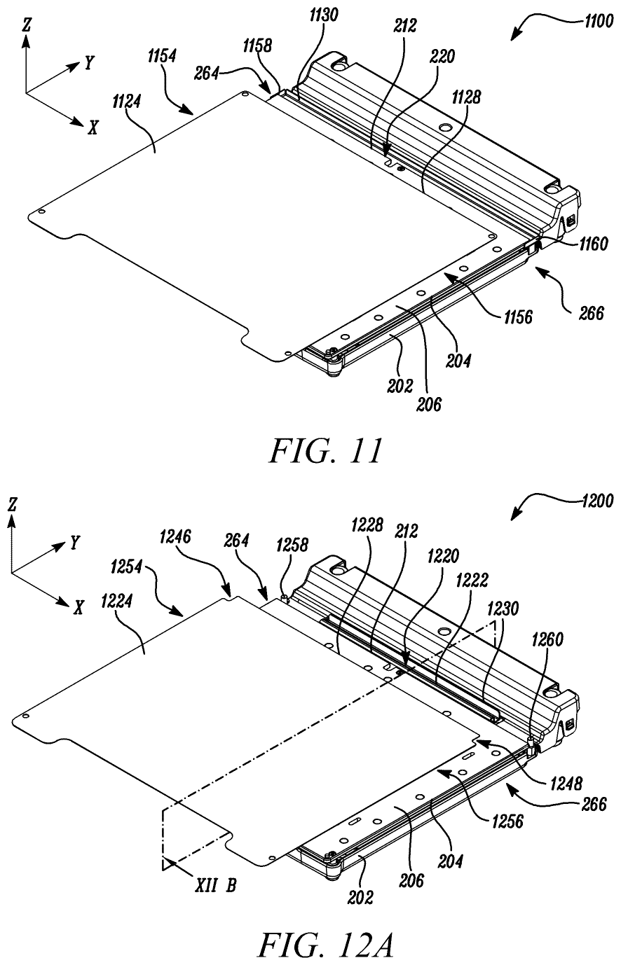

FIG. 11 illustrates a print bed assembly 1100, according to another embodiment of the present invention. The print bed assembly 1100 of FIG. 11 is substantially similar to the print bed assembly 200 of FIGS. 2, 3, and 5 in terms of functionality. The print bed assembly 1100 comprises a stage 202, a carrier plate 204, a print bed cover 216, and a support structure 220 comprising a straight edge 222 as described above. The print bed assembly 1100 also comprises a build plate 1124 to be placed on the carrier plate 204. The build plate 1124 differs from the build plate 224 (see FIGS. 2, 3, and 5). The build plate 1124 defines a rear edge 1128. The rear edge 1128 extends between opposing ends 1154, 1156 of the build plate 1124 along the X-direction. It should be noted that details related to the positioning of the build plate 224 of the print bed assembly 200 in the first and second states S1, S2 (as illustrated and explained in relation to FIGS. 3 and 2, respectively) are equally applicable to a positioning of the build plate 1124 of the print bed assembly 1100.

Further, the print bed assembly 1100 comprises at least one Y-alignment structure 1130. The at least one Y-alignment structure 1130 comprises one or more profiles herein. The print bed assembly 1100 comprises a single Y-alignment structure 1130 herein that extends along the X-direction between the opposing ends 264, 266 of the stage 202. In the embodiment of FIG. 11, the Y-alignment structure 1130 is embodied as a substantially vertical member extending from the stage 202 in the Z-direction. The Y-alignment structure 1130 is arranged to align the build plate 1124 relative to the carrier plate 204 in the Y-direction. Specifically, in a first state (i.e., during an insertion of the build plate 1124) of the build plate 1124, the Y-alignment structure 1130 aligns the build plate 1124 in the Y-direction. Moreover, in a second state (i.e., when the build plate 1124 is placed on the carrier plate 204) of the build plate 1124, the Y-alignment structure 1130 prevents any movement of the build plate 1124 along the Y-direction.

Further, the print bed assembly 1100 comprises at least one X-alignment structure 1158, 1160 arranged to align the build plate 1124 relative to the carrier plate 204 in the X-direction. The at least one X-alignment structure 1158, 1160 comprises one or more profiles herein. In the embodiment of FIG. 11, the print bed assembly 1100 comprises two X-alignment structures 1158, 1160. The X-alignment structures 1158, 1160 extend along the Y-direction and are disposed at the respective opposing ends 264, 266 of the stage 202. Further, the X-alignment structures 1158, 1160 are substantially parallel to each other. Moreover, the Y-alignment structure 1130 is substantially perpendicular to each X-alignment structure 1158, 1160. In the embodiment of FIG. 11, each X-alignment structure 1158, 1160 is embodied as a substantially vertical member extending from the stage 202 in the Z-direction. In the first state of the build plate 1124, each X-alignment structure 1158, 1160 aligns the build plate 1124 in the X-direction. Moreover, in the second state of the build plate 1124, each X-alignment structure 1158, 1160 prevents any movement of the build plate 1124 along the X-direction.

In the embodiment of FIG. 11, the X-alignment structures 1158, 1160 and the Y-alignment structure 1130 are manufactured as separate components. Alternatively, the X-alignment structures 1158, 1160 and the Y-alignment structure 1130 may be integral and manufactured as a single component. For example, the X-alignment structures 1158, 1160 and the Y-alignment structure 1130 may together form a U-shaped XY-alignment structure. The Y-alignment structure 1130 and the X-alignment structures 1158, 1160 may be made of any material comprising, but not limited to, metals or ceramics. In an example, the Y-alignment structure 1130 and the X-alignment structures 1158, 1160 may be made from a sheet metal. The Y-alignment structure 1130 and the X-alignment structures 1158, 1160 may have a simple design, may be easy to incorporate, and may be cost-effective to manufacture.

Further, when the build plate 1124 is in the first state, the build plate 1124 touches each of the straight edge 222 of the support structure 220, the at least one Y-alignment structure 1130, and the at least one X-alignment structure 1158, 1160. Moreover, when the build plate 1124 is rotated downwards into the second state, the build plate 1124 still touches the at least one Y-alignment structure 1130 and the at least one X-alignment structure 1158, 1160.

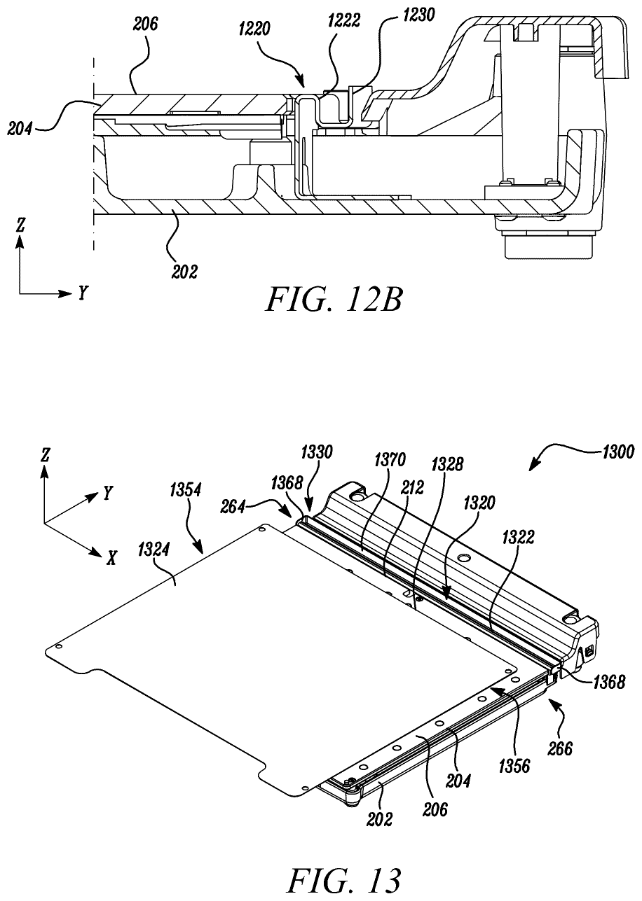

FIG. 12A illustrates a print bed assembly 1200, according to yet a further embodiment of the present invention. The print bed assembly 1200 of FIG. 12A is substantially similar to the print bed assembly 200 of FIGS. 2, 3, and 5 in terms of functionality. The print bed assembly 1200 comprises a stage 202 and a carrier plate 204 similar to those described above. The print bed assembly 1200 also comprises a build plate 1224 to be placed on the carrier plate 204. The build plate 1224 differs from the build plate 224 (see FIGS. 2, 3, and 5). The build plate 1224 comprises a pair of cut-outs 1246, 1248 disposed at opposing ends 1254, 1256 of the build plate 1224. The cut-outs 1246, 1248 are substantially rectangular in shape. The build plate 1224 defines a rear edge 1228 extending along the X-direction and disposed between the cut-outs 1246, 1248. It should be noted that details related to the positioning of the build plate 224 of the print bed assembly 200 in the first and second states S1, S2 (as illustrated and explained in relation to FIGS. 3 and 2, respectively) are equally applicable to a positioning of the build plate 1224 of the print bed assembly 1200.

Further, the print bed assembly 1200 comprises at least one X-alignment structure 1258, 1260 arranged to align the build plate 1224 relative to the carrier plate 204 in the X-direction. Specifically, the print bed assembly 1200 comprises two X-alignment structures 1258, 1260. The X-alignment structures 1258, 1260 are spaced apart from each other in the X-direction and disposed at the respective opposing ends 264, 266 of the stage 202. In the embodiment of FIG. 12A, the X-alignment structures 1258, 1260 align the build plate 1224 relative to the carrier plate 204 in the X-direction. Specifically, in a first state (i.e., during an insertion of the build plate 1224) of the build plate 1224, the X-alignment structures 1258, 1260 align the build plate 1224 in the X-direction. The X-alignment structures 1258, 1260 engage with the corresponding cut-outs 1246, 1248 in the build plate 1224 to align the build plate 1224 in the X-direction. Moreover, in a second state (i.e., when the build plate 1224 is placed on the carrier plate 204) of the build plate 1224, the X-alignment structures 1258, 1260 prevent any movement of the build plate 1224 along the X-direction.

Each X-alignment structure 1258, 1260 comprises a pin herein. The X-alignment structures 1258, 1260 are interchangeably referred to as the pins 1258, 1260. It should be noted that each X-alignment structure 1258, 1260 is substantially similar in design to the Y-alignment structures 230, 232 explained in relation to FIGS. 3 and 4. Alternatively, the X-alignment structures 1258, 1260 may be substantially similar in design to the Y-alignment structures 630, 632 explained in relation to FIG. 6.

Further, the print bed assembly 1200 comprises at least one Y-alignment structure 1230. In the embodiment of FIG. 12A, the Y-alignment structure 1230 is embodied as a substantially vertical member extending from the stage 202 along the Z-direction. The Y-alignment structure 1230 is centrally located between the opposing ends 264, 266 of the stage 202. The Y-alignment structure 1230 is arranged to align the build plate 1224 relative to the carrier plate 204 in the Y-direction. Specifically, in the first state of the build plate 1224 (i.e. with the build plate inserted under angle), the Y-alignment structure 1230 aligns the build plate 1224 in the Y-direction. The Y-alignment structure 1230 engages with the rear edge 1228 of the build plate 1224 to align the build plate 1224 in the Y-direction. Moreover, in the second state of the build plate 1224, the Y-alignment structure 1230 prevents any movement of the build plate 1224 along the Y-direction.

FIG. 12B shows a side cross-sectional view of part of the embodiment of FIG. 12A. As is shown in FIG. 12B, the print bed assembly 1200 comprises a support structure 1220 arranged on the stage 202 and comprising a straight edge 1222 extending in the X-direction. In the embodiment of FIG. 12A, the support structure 1220 is separate from the carrier plate 204. The support structure 1220 is disposed between the carrier plate 204 and the Y-alignment structure 1230. The support structure 1220 and the Y-alignment structure 1230 are substantially parallel to each other. Moreover, the support structure 1220 and the Y-alignment structure 1230 are integral with each other. The support structure 1220 and the Y-alignment structure 1230 may be made of any material comprising, but not limited to, metals or ceramics. In an example, the support structure 1220 and the Y-alignment structure 1230 may be made from a sheet metal. The support structure 1220 and the Y-alignment structure 1230 may have a simple design, may be easy to incorporate, and may be cost-effective to manufacture.

When the build plate 1224 is placed correctly in the first (i.e. tilted) state, the build plate 1224 touches each of the straight edge 1222 of the support structure 1220, the at least one Y-alignment structure 1230, and the at least one X-alignment structure 1258, 1260. Moreover, when the build plate 1224 is in the second (i.e. flat) state, the build plate 1224 still touches the at least one Y-alignment structure 1230 and the at least one X-alignment structure 1258, 1260.

FIG. 13 illustrates a print bed assembly 1300, according to an embodiment of the present invention. The print bed assembly 1300 of FIG. 13 is substantially similar to the print bed assembly 200 of FIGS. 2, 3, and 5 in terms of functionality. The print bed assembly 1300 comprises a stage 202 and a carrier plate 204 similar to those described above. The print bed assembly 1300 also comprises a build plate 1324 to be placed on the carrier plate 204. The build plate 1324 differs from the build plate 224 (see FIGS. 3, 4, and 5). The build plate 1324 defines a rear edge 1328. The rear edge 1328 extends between opposing ends 1354, 1356 of the build plate 1324 along the X-direction. It should be noted that details related to the positioning of the build plate 224 of the print bed assembly 200 in the first and second states S1, S2 (as illustrated and explained in relation to FIGS. 3 and 2, respectively) are equally applicable to a positioning of the build plate 1324 of the print bed assembly 1300.

Further, the print bed assembly 1300 comprises at least one Y-alignment structure 1330. Specifically, the print bed assembly 1300 comprises a single Y-alignment structure 1330. The Y-alignment structure 1330 extends between the opposing ends 264, 266 of the stage 202. In the embodiment of FIG. 13, the Y-alignment structure 1330 is substantially U-shaped. Specifically, the Y-alignment structure 1330 comprises a pair of first portions 1368 and a second portion 1370 connected to and extending between the pair of first portions 1368. The first portions 1368 extend along the Y-direction, whereas the second portion 1370 extends along the X-direction. The first portions 1368 are disposed at the respective opposing ends 264, 266 of the stage 202 and the first portions 1368 are parallel to each other. Further, the second portion 1370 is substantially perpendicular to each first portion 1368.

In the embodiment of FIG. 13, the pair of first portions 1368 and the second portion 1370 are integral with each other. The Y-alignment structure 1330 is arranged to align the build plate 1324 relative to the carrier plate 204 in the Y-direction. Specifically, in a first state (i.e., during an insertion of the build plate 1324) of the build plate 1324, the second portion 1370 of the Y-alignment structure 1330 aligns the build plate 1324 in the Y-direction. Moreover, in a second state (i.e., when the build plate 1324 is placed on the carrier plate 204) of the build plate 1324, the second portion 1370 prevents any movement of the build plate 1324 along the Y-direction. In the embodiment of FIG. 13, the Y-alignment structure 1330 also aligns the build plate 1324 in the X-direction. Specifically, in the first state of the build plate 1324, the first portions 1368 of the Y-alignment structure 1330 align the build plate 1324 in the X-direction. Moreover, in the second state of the build plate 1324, the first portions 1368 may prevent any movement of the build plate 1324 along the X-direction. It should be noted that the Y-alignment structure 1330 may be referred to as an “XY-alignment structure” as it aligns the build plate 1324 in each of the X-direction and the Y-direction.

Further, the print bed assembly 1300 comprises a support structure 1320 arranged on the stage 202 and comprising a straight edge 1322 extending in the X-direction. In the embodiment of FIG. 13, the support structure 1320 is separate from the carrier plate 204. The support structure 1320 is disposed between the carrier plate 204 and the Y-alignment structure 1330. The support structure 1320 and the second portion 1370 of the Y-alignment structure 1330 are substantially parallel to each other. Moreover, the support structure 1320 and the Y-alignment structure 1330 are integral with each other. The support structure 1320 and the Y-alignment structure 1330 may be made of any material comprising, but not limited to, metals or ceramics. In an example, the support structure 1320 and the Y-alignment structure 1330 may be made from a sheet metal. The support structure 1320 and the Y-alignment structure 1330 may have a simple design, may be easy to incorporate, and may be cost-effective to manufacture.

It should be noted that, when the build plate 1324 is in the first state S1, the build plate 1324 touches the straight edge 1322 of the support structure 1320 and the at least one Y-alignment structure 1330. Moreover, when the build plate 1324 is in the second state, the build plate 1324 still touches the at least one Y-alignment structure 1330.

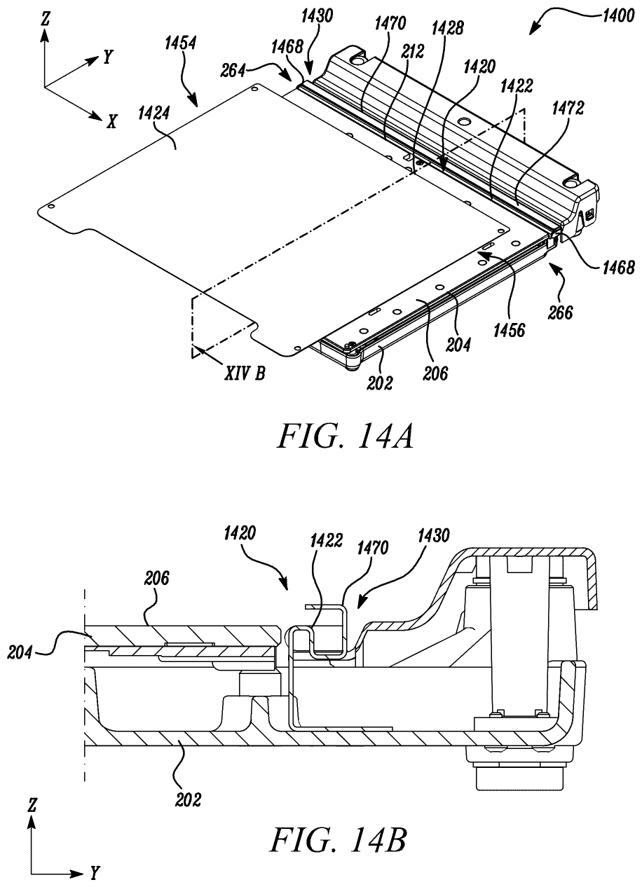

FIG. 14A illustrates a print bed assembly 1400, according to an embodiment of the present invention. The print bed assembly 1400 of FIG. 14A is substantially similar to the print bed assembly 200 of FIGS. 2, 3A, and 5 in terms of functionality. The print bed assembly 1400 comprises a stage 202 and a carrier plate 204 similar to those described above. The print bed assembly 1400 also comprises a build plate 1424 to be placed on the carrier plate 204. The build plate 1424 differs from the build plate 224 (see FIGS. 2, 3A, and 5). The build plate 1424 defines a rear edge 1428. The rear edge 1428 extends between opposing ends 1454, 1456 of the build plate 1424 along the X-direction. It should be noted that details related to the positioning of the build plate 224 of the print bed assembly 200 in the first and second states S1, S2 (as illustrated and explained in relation to FIGS. 3A and 5, respectively) are equally applicable to a positioning of the build plate 1424 of the print bed assembly 1400.

FIG. 14B shows a side cross-sectional view of part of the embodiment of FIG. 14A. As is shown in FIG. 14B, the print bed assembly 1400 comprises at least one Y-alignment structure 1430. Specifically, the print bed assembly 1400 comprises a single Y-alignment structure 1430 herein. The Y-alignment structure 1430 extends between the opposing ends 264, 266 of the stage 202. In this embodiment, the Y-alignment structure 1430 is substantially U-shaped. Specifically, the Y-alignment structure 1430 comprises a pair of first portions 1468 and a second portion 1470 connected to and extending between the pair of first portions 1468, see also FIG. 14A. The first portions 1468 are disposed at the respective opposing ends 264, 266 of the stage 202 and extend along the Y-direction. Further, the second portion 1470 extends along the X-direction between the opposing ends 264, 266 of the stage 202. The first portions 1468 are substantially parallel to each other. Moreover, the second portion 1470 is substantially perpendicular to each first portion 1468. In the embodiment of FIGS. 14A and 14B, the pair of first portions 1468 and the second portion 1470 are integral with each other.

The Y-alignment structure 1430 is arranged to align the build plate 1424 relative to the carrier plate 204 in the Y-direction. Specifically, in a first state (i.e., during an insertion of the build plate 1424) of the build plate 1424, the second portion 1470 of the Y-alignment structure 1430 aligns the build plate 1424 in the Y-direction. Moreover, in a second state (i.e., when the build plate 1424 is placed on the carrier plate 204) of the build plate 1424, the second portion 1470 prevents any movement of the build plate 1424 along the Y-direction. In the embodiment of FIG. 14A, the Y-alignment structure 1430 also aligns the build plate 1424 in the X-direction. Specifically, in the first state of the build plate 1424, the first portions 1468 of the Y-alignment structure 1430 align the build plate 1424 in the X-direction. Moreover, in the second state of the build plate 1424, the first portions 1468 may prevent any movement of the build plate 1424 along the X-direction. The Y-alignment structure 1430 may be referred to as an “XY-alignment structure” as it aligns the build plate 1424 in each of the X-direction and the Y-direction.

Further, the print bed assembly 1400 comprises a support structure 1420 arranged on the stage 202 and comprising a straight edge 1422 extending in the X-direction. In the embodiment of FIGS. 14A and 14B, the support structure 1420 is separate from the carrier plate 204. The support structure 1420 is disposed between the carrier plate 204 and the Y-alignment structure 1430. The support structure 1420 and the second portion 1470 of the Y-alignment structure 1430 are substantially parallel to each other.

In the embodiment of FIGS. 14A and 14B, the print bed assembly 1400 further comprises a locking member 1472. The locking member 1472 extends along the X-direction. The locking member 1472 extends between and is connected to the first portions 1468 of the Y-alignment structure 1430. Moreover, the locking member 1472 is connected to the second portion 1470 and extends orthogonally from the second portion 1470. When the build plate 1424 is in the second state, the locking member 1472 prevents any movement of the build plate 1424 along the Z-direction. Thus, the locking member 1472 provides an additional locking feature for the build plate 1424. Further, the support structure 1420, the Y-alignment structure 1430, and the locking member 1472 are integral with each other. The support structure 1420, the Y-alignment structure 1430, and the locking member 1472 may be made of any material comprising, but not limited to, metals or ceramics. In an example, the support structure 1420, the Y-alignment structure 1430, and the locking member 1472 may be made from a sheet metal. The support structure 1420, the Y-alignment structure 1430, and the locking member 1472 may have a simple design, may be easy to incorporate, and may be cost-effective to manufacture.

Further, when the build plate 1424 is in the first state, the build plate 1424 touches the straight edge 1422 of the support structure 1420 and the at least one Y-alignment structure 1430. In an example, the build plate 1424 may also touch the locking member 1472, for example, to align the build plate 1424 in the Z-direction. Moreover, when the build plate 1424 is in the second state, the build plate 1424 still touches the at least one Y-alignment structure 1430 and also touches the locking member 1472.

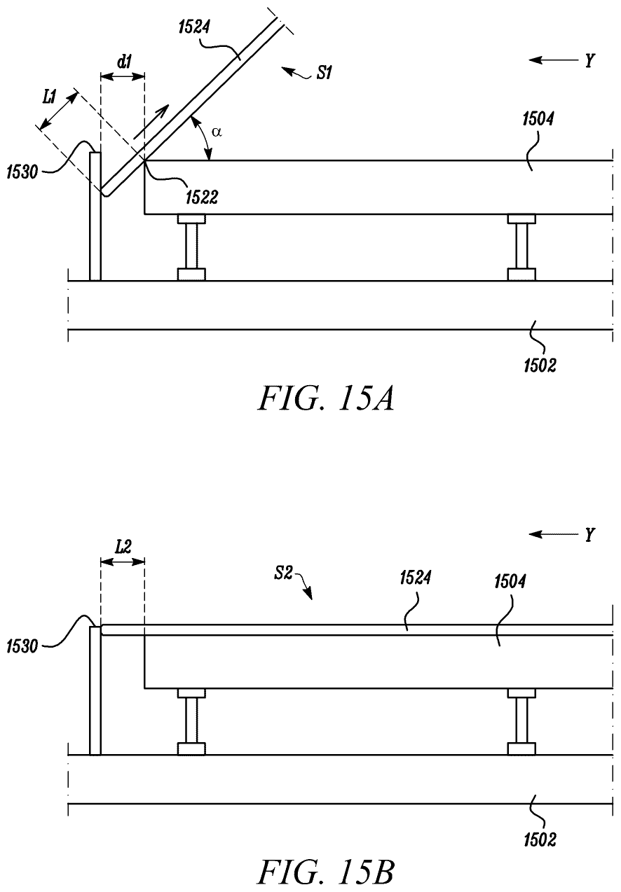

It is noted that in the above described embodiments, during rotation of the build plate 224, 924, 1024, 1124, 1224 from the tilted state S1 to the installed state S2, the build plate is rotated around the straight edge of the carrier plate 204 or of the separate support structure 1222, but since the abutment(s) (e.g. pins 230, 232) extends in the Z-direction and the build plate continuously touches this abutment (due to a slight force applied by e.g. a user), the build plate will also slightly move forward, i.e. in the reverse Y direction. This mechanism will be explained in more detail with reference to FIGS. 15A and 15B.

FIG. 15A schematically shows a side view of part of an embodiment wherein the build plate is in the first state S1. The build plate may be positioned in this state by a user which places the build plate on the straight edge of the support structure, in this case, the top edge 1522 of the rear side of the carrier plate 1504. In state S1, the build plate makes an angle a with a top surface of the carrier plate 1504.

In FIG. 15A a distance d1 between the abutment 1530 and the rear top edge 1522 of the carrier plate 1504 is indicated. In state S1 the build plate 1524 extends beyond the rear side of the carrier plate by a length equal to L1=d1/sin(αn). In the final state S2, see FIG. 15B, the build plate 1524 exceeds the back side of the carrier plate by a length L2 equal to d1. By rotating the build plate from S1 to S2, the build plate will, next to rotating, also move in a direction opposite of the Y-direction, since L2 is smaller than L1. This slight lateral movement is not influencing the alignment, since the rear end of the build plate 1504 will always stay aligned to the Y-alignment structure (i.e. the abutment 1530), which is due to the construction.

As a result, once the build plate has been placed in the installed state S2, it does not need any final correction of its position. This is favourable especially in systems were the build plate comprises metal and is stuck onto the carrier plate by means of magnets, but also in embodiments where a high friction is present between the build plate and the carrier plate.

The present invention has been described above with reference to a number of exemplary embodiments as shown in the drawings. Modifications and alternative implementations of some parts or elements are possible and are comprised in the scope of protection as defined in the appended claims. It should be noted that the above-mentioned embodiments illustrate rather than limit the invention, and that those skilled in the art will be able to design many alternative embodiments. It is also noted that the invention can be implemented in other additive manufacturing devices, such as Selective Lase Sintering systems, or any other additive manufacturing system using a build plate that needs to be aligned upon a carrier. In the claims, any reference signs placed between parentheses shall not be construed as limiting the claim. Use of the verb comprise and its conjugations does not exclude the presence of elements or steps other than those stated in a claim. The article ‘a’ or ‘an’ preceding an element does not exclude the presence of a plurality of such elements. The mere fact that certain measures are recited in mutually different dependent claims does not indicate that a combination of these measures cannot be used to advantage.

1. A print bed assembly for an additive manufacturing system, the print bed assembly comprising:
a stage;
a carrier plate arranged on the stage, the carrier plate comprising an upper surface extending in an X-direction and a Y-direction perpendicular to the X-direction;
a support structure arranged on the stage and comprising a straight edge extending in the X-direction;
a build plate to be placed on the carrier plate; and
at least one abutment arranged on the stage and spaced apart from the straight edge of the support structure, the at least one abutment being arranged for limiting movement of the build plate relative to the carrier plate in the Y-direction, when the build plate is placed on the straight edge of the support structure at an angle relative to the upper surface of the carrier plate.

2. The print bed assembly according to claim 1, further comprising at least one X-alignment structure arranged to align the build plate relative to the carrier plate in the X-direction.

3. The print bed assembly according to claim 2, wherein the at least one X-alignment structure comprises one or more pins extending from the stage up to a level higher than a level of the upper surface of the carrier plate.

4. The print bed assembly according to claim 2, wherein the at least one X-alignment structure comprises one or more profiles extending from the stage up to a level higher than a level of the upper surface of the carrier plate.

5. The print bed assembly according to claim 1, wherein the at least one abutment comprises one or more profiles extending from the stage up to a level higher than a level of the upper surface of the carrier plate.

6. The print bed assembly according to claim 1, wherein the at least one abutment comprises one or more pins extending from the stage up to a level higher than a level of the upper surface of the carrier plate.

7. The print bed assembly according to claim 6, wherein the build plate comprises one or more cut-outs at its rear side to receive the one or more pins.

8. The print bed assembly according to claim 7, wherein at least one of the one or more cut-outs has a V-shape and at least another cut-out has a U-shape.

9. The print bed assembly according to claim 6, wherein each of the one or more pins comprises a body portion and a head portion, and wherein the head portion of the pin is configured to lock with the build plate when the build plate is arranged on the carrier plate.

10. The print bed assembly according to claim 1, wherein the support structure is separate from the carrier plate.

11. The print bed assembly according to claim 1, wherein the support structure is an integral part of the carrier plate.

12. The print bed assembly according to claim 1, wherein the build plate comprises a metal flexible plate, and the carrier plate comprises one or more magnets.

13. The print bed assembly according to claim 1, wherein the build plate comprises two extensions at a rear side of the build plate, and wherein the carrier plate comprises two slopes for guiding the extensions during placement of the build plate onto the carrier plate.

14. An additive manufacturing system comprising the print bed assembly according to claim 1.
